(19) United States
(12) Patent Application Publication
(10) Pub. No.: US 2016/0283986 A1
(43) Pub. Date: Sep. 29, 2016

(54) METHODS AND SYSTEMS TO MAKE SURE THAT THE VIEWER HAS COMPLETELY WATCHED THE ADVERTISEMENTS, VIDEOS, ANIMATIONS OR PICTURE SLIDES

(71) Applicant: GEORGE VICTOR K J, AROOR (IN)

(72) Inventor: GEORGE VICTOR K J, AROOR (IN)

(21) Appl. No.: 15/078,483

(22) Filed: Mar. 23, 2016

Related U.S. Application Data
(60) Provisional application No. 62/137,251, filed on Mar. 24, 2015.

(51) Int. Cl. G06Q 30/02; G06F 3/0488; G06F 3/01; G06F 9/44

(52) U.S. Cl. CPC G06Q 30/0277; G06F 9/4446; G06F 3/04883; G06F 3/013

(57) ABSTRACT

Systems and methods to detect if the viewer of an advertisement is constantly watching the advertisement till it finished. The invention utilizes the principle that the only foolproof way to make sure that user has watched an advertisement fully is by asking him/her to perform some simple, user-experience-friendly but unpredictable actions while the content is being played without distracting the user away from the content. It can be random actions, or fixed actions occurring at a random place or both. The interval can be fixed or random too. According to the user response, the further actions can be customized, like pausing or replaying the advertisement if the user response was wrong. Also the complete user response data can be captured and analyzed.

### CROSS-REFERENCE TO RELATED APPLICATIONS

This application claims the benefit of U.S. provisional patent application No. 62/137,251, filed Mar. 24, 2015.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention is in the technical field of networked advertising systems. More particularly, the present invention is related to a computer method and system for making sure that the user of a web/mobile or desktop application pays attention to the advertisement being played.

### BACKGROUND OF THE INVENTION

The online advertising has been growing very fast and especially the video based advertisements. Any advertisement (not necessarily the online advertisement) will be more effective when the viewer/user of that advertisement not only just see it, but also pay attention to it. The problem with video or animation based online advertisement is that, there is no way currently to make sure that the user has watched the advertisement properly. It is very easy do something else while the advertisement is being played, such as

A. minimizing the software application which has advertisement,

B. if the advertisement is in a web page, open a different browser window or tab

C. simply not look at the advertisement, even if it is being played in the fore-ground. (A typical example is watching videos in a typical video hosting website like YouTube. The website may play advertisement videos just before playing the video the user searched for. But the user can just look at somewhere else till the advertisement is completed—without minimizing the window or open a new tab—and then come back to see the actual video he/she wanted to watch. So whoever paid for that particular advertisement is not getting any benefit in such a scenario. Also the video hosting website is not been able to make sure that all their viewers/users have watched the advertisement)

There are many techniques currently available to address problems A and B. There are many ways to detect if the software application—where the advertisement is played—is running in the background or lost focus or if the user is idle (the idle time check is also not very helpful, as the viewer/user can easily fool this by moving his mouse or pressing any key or doing some touch based gestures for mobile devices, still without looking at the advertisement).

But, at present, there are no effective ways to tackle problem C—i.e., to make sure that viewer/user has to watch the advertisement till it is finished in an easy and non-intrusive way. There can be some naive ways to make sure that the user has paid attention to the advertisement, such as asking some questions (which may or may not be related to the advertisement) to the viewer during/after advertisement, but that would be completely non-user-friendly for the viewer (bad user experience) and may result in extra work for the advertiser/or the software application owner to have multiple questionnaires and relate it to each advertisement. Furthermore, in small form factor devices—such as mobile devices—typing during/after advertisement (typically the advertisement may be a video which is being played in the full screen) can be very irritating and intrusive to the viewer.

So it would be advantageous to have an improved system and method for making sure that viewer has to look at the advertisement till it is finished in an easy and non-intrusive way and/or provide an insightful data to the advertiser to analyze the viewer's alertness.

Definitions

The terms below, as used herein, shall have the meaning associated therewith:

‘Non-intrusive’ actions—in the context of this invention, it means that the user has to perform something, which will not block or stop the user from watching the digital content. Moving the mouse/ finger, or clicking/touching some area is non-intrusive. But if the user has to type or press any key is intrusive, as it can be tough for the user to perform in a mobile device especially if video is playing in full screen mode.

‘user-experience-friendly’ actions—actions that provides a good user experience to the user.

‘simple’ actions—anything that is easier to perform by a user in terms of time and effort required. Moving mouse, swiping in a touch enabled device, clicking or touching are simple tasks. These are all simple tasks that user can perform, without getting distracted. Answering a questionnaire at the end of watching a digital content is not simple.

digital content—Any digital media which can be played over a period of time. Digital content can be videos, animations, picture slides etc.

### SUMMARY OF THE INVENTION

The present invention provides methods and systems to make sure that the viewer (hereinafter referred to as “user”) of any advertisement/digital content being played (hereinafter referred to as “video”, but it can be any form of an advertisement which can be played over a period of time, such as a video, animation, picture slide etc.) has to pay attention to the video, by asking them to perform some very simple actions which will not hamper their viewing experience, especially on a mobile device.

It is another principal object of the present invention to have a better user experience while making sure that the user watched the video completely. The action to be performed by the user has to be a very simple and non-intrusive, such as moving the mouse pointer (using mouse, track pad etc.) or finger (for touch based devices), clicking or touching or doing other touch gestures.

It is another principal object of the present invention to provide useful information to the advertiser (who pays for the videos/advertisements) or to the software application owner (who hosts the videos/advertisements) to analyze the user interactions. Various types of data (related to user actions) can be captured such as how many times the user failed to perform the required actions, which part of the video they missed, the patterns for misses etc.

The present invention calculates/gets the duration of the video and at a random interval, asks the user to do some unpredictable actions in a non-intrusive way. It could be anything like showing the user an image with an arrow in a specified direction and the user must move his/her mouse/finger in the same direction to prove that he/she was actually looking at the video. The small overlay where such actions occur (referred to as ‘action area’) can be kept on top of the video or near it. It can even show a more complex image to the user like a spiral or a circle and expects user to move the mouse/finger roughly in the same way. Instead of showing an image it can be drawn on-the-fly also (using something like HTML 5 canvas or Flash or Applets). If the user responds correctly, then the video goes on smoothly. If not, the video can be paused until the user responds, or the platform can track how many times the user missed the expected actions and also determine the next actions. Basically the advertiser can either force the user to watch the video by pausing and not proceeding until the required actions are not performed by the user, or else play the video without interruption but track how many times the user missed and plan a different action for the user (e.g.: if the miss rate is greater than 50%, replay the video).

It is another principal object of the present invention to alternatively make use of advanced techniques such as examining the eye movements of the user, and based on that determine if the user is paying attention to the digital content being played.

### BRIEF DESCRIPTION OF THE DRAWINGS

FIG. 1 is a block flow chart of the information flow that occurs in the present invention;

FIGS. 2a and 2b illustrate a user interface implemented using a “Fixed Action Area and Dynamic Actions” in accordance with an embodiment of the present invention;

FIGS. 3a and 3b illustrate a user interface implemented using a “Dynamic Action Area and Fixed Actions” in accordance with an embodiment of the present invention;

FIGS. 4a and 4b illustrate a user interface implemented using a “Dynamic Action Area and Dynamic Actions” in accordance with an embodiment of the present invention;

### DETAILED DESCRIPTION OF THE INVENTION

The principles and operations of the methods and systems according to the present invention may be better understood with reference to the drawings and the accompanying description, it being understood that these drawings are given for illustrative purposes only and are not meant to be limiting. Also, it is to be understood that the terminology employed herein is for the purpose of description and not of limitation. In various non-limiting embodiments, the invention is described in the context of a video based advertising system.

The following are the terminologies used in the figures as well as in various places of this specification and to understand what they really mean in the context of this invention may be beneficial for understanding this invention clearly.
a. “video” means any form of an advertisement which can be played over a period of time, such as a video, animation, picture slide etc.
b. “user” means the viewer of the video.
c. “advertiser” is the person who pays for displaying the video(advertisement).
d. “app” is the software/main application where the video is displayed. It can be any software application where a video can be played. E.g.: web application, desktop application, mobile application, apps on wearable devices, televisions etc.
e. “lib” is a library module which embodies the methods and systems disclosed in this invention. This can be part of the app itself or work as a stand-alone module. The communication between an app and a lib can be implemented using different techniques available in computer programming. Lib can be customized with different settings.
f. “software application owner” is the person who owns the app. Typically a software application owner gets paid from an advertiser to display the videos (advertisements)
g. “action” or “expected user action” refers to the action which the lib shows to the user. The user is expected to respond back to the action shown to him/her. Action can be anything like showing the user an image with an arrow in a specified direction. It can even show a more complex image to the user like a spiral or a circle. Instead of showing an image it can be drawn on-the-fly also (using something like HTML 5 canvas or Flash or Applets). It can be an animation too. Even audible actions can be used to make sure that the user is listening to the audio too. Simple audio commands like ‘move up’ or ‘draw a circle’ can be played as actions. The core principle of this invention is to create an unpredictable action (by using dynamic actions, or dynamic action area or both, combined with random/fixed intervals) so that the user has to watch the video continuously until it is finished
h. “response” or “action performed” refers to the actual response that the user does, in accordance with an action. Response should be simple, easy to perform and non-intrusive. It should be something which can be easily performed even on a mobile device with minimum distraction to the user. E.g.: move the mouse pointer using mouse or track pad, swipe or moving the finger on a touch-based device, clicking the mouse on or around a specific place, touch or pinch on/around a specific region on a touch-based device etc. A typical implementation would expect the user to respond by moving his/her mouse/finger to draw the same shape as shown in the action to prove that he/she was actually looking at the video.
i. “correct response” or “success” means that the action and response matched.
j. “incorrect response” or “failure” means that the action and response did not match.
k. “timed out” means that the user did not respond even after some specific time period after the action is displayed.
l. “action area” is the place where the action is shown to the user. This can be placed over the video or somewhere around the video so that the user can see the actions simultaneously while watching the video.
m. “response area” is the place where the response is performed by the user. This can be even the main app itself (means user can move his fingers/mouse anywhere on the app) or a specific area within the app (such as the video player itself)

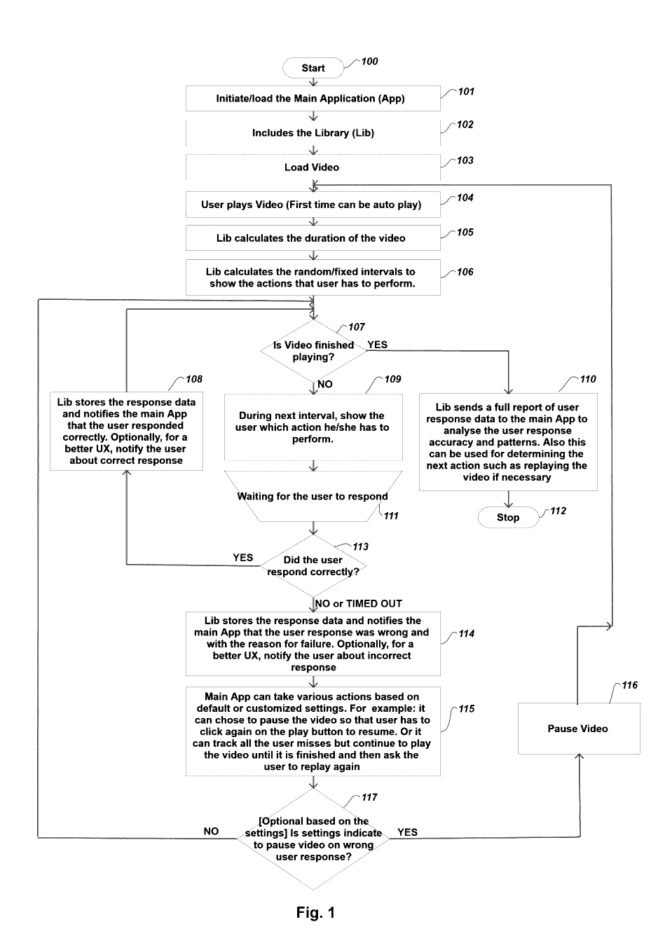

Referring now to FIG. 1, there is shown the flow chart of the method of the present invention, constructed according to the principles of the present invention. Once the main app is started 101, it will include the lib 102 which contains the software logic which implements the methods and systems of this invention. The main app loads the video (advertisement) 103 and the video will be either auto played in the beginning or the user plays it 104. The duration of the video can be communicated to the lib from the app or lib calculates the same by its own from the video 105. It is important to get to know the duration of the video in order to know when to stop showing the actions, as well as to calculate intervals to show the actions 106. Intervals can be fixed or random intervals. The number of intervals should be calculated in such a way that there is a balance between the User Experience (too many actions are bad) and making sure that user is watching the video actively (too less actions won't be sufficient). If the video is not yet finished 107, show an action to the user in the next interval 109. Then the lib will wait for a set period of time for the user to respond 111.

If the user performs a ‘correct response’ 113, then the lib stores the response data and notifies the main app that the user responded correctly and optionally notifies the user that the response was success for a better user experience 108. Then the control goes to 107 again to check if the video has finished or not.

If the user performs an ‘incorrect response’ 113, then the lib stores the response data and notifies the app that the response was wrong along with the reason for failure (such as incorrect response or timed out) and optionally notifies the user that the response was incorrect in order to enhance the user experience 114. Main app can take various actions based on default or customized settings 115. For an example it can stop playing the video if the settings is like that or it can just record the misses but continue to play the video.

If the settings is to pause the video 117, then pause it 116. Then the user has to explicitly play the video again 104 from the paused state. If the setting is to NOT to pause the video 117, then go to 107 to check if the video has finished playing.

If the video has completed playing 107, then the Lib send a complete report of user response data to the app 110. This data can be used for various analyses of user response accuracy and patterns. Based on settings, the video can be automatically replayed too, if the user misses are not in acceptable range.

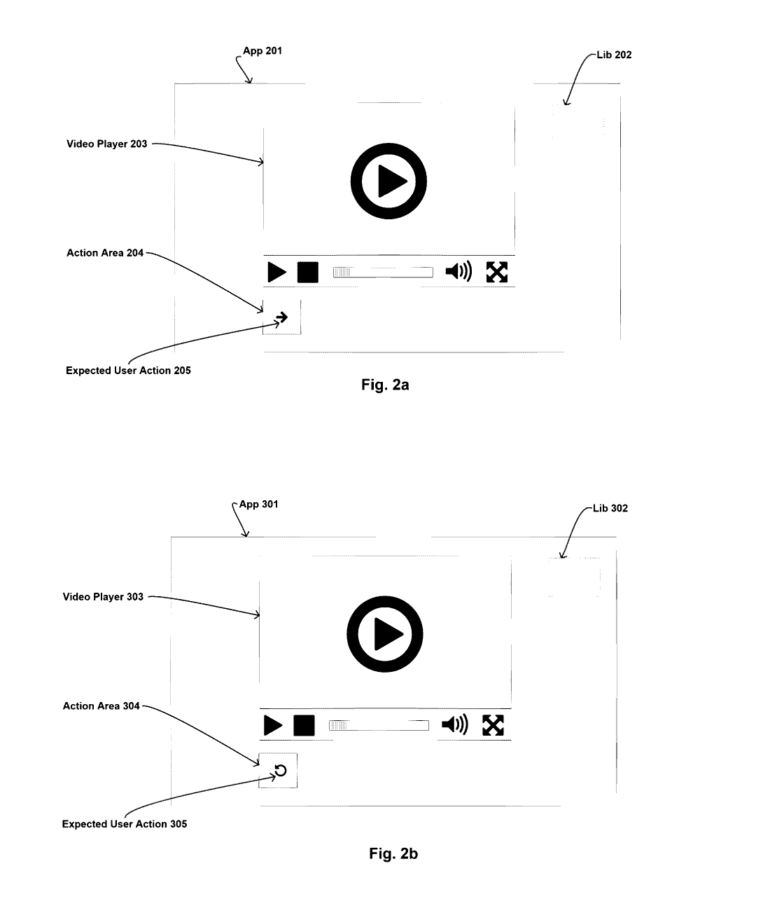

Referring now to FIGS. 2a and 2b, they illustrate a user interface implemented using a “Fixed Action Area and Dynamic Actions” in accordance with an embodiment of the present invention. App is the main software component which holds every other component 201. App can be implemented in any computer programming language. Lib can be included or loaded as a separate module or a sub component of the app 202. App also holds a video player written in the supported computer programming language 203. The action area is the place where the actions are shown to the user 204. Here the action area is a fixed one, i.e., the user needs to look at only one place every time to see the actions. The actions can be different but it will always appear at one fixed place. This action area can be placed anywhere in the app, on or around the video player. Expected user action appears inside the action area at the calculated intervals (intervals can be random or fixed) 205.

Still referring to FIG. 2a, the action 205 is an image indicating that the user should move the mouse or finger towards right. So the user has to respond by moving the mouse or finger towards his/her right. If he/she does that correctly, the response is correct, the video will be played without any interruption and the response is recorded. If the user response is incorrect, i.e., if the user moved his mouse to any other direction apart from towards his right or if the response is timed out, then the lib records the response and notifies the app about the same. App can chose to decide the next action based on settings.

Referring to FIG. 2b, this is the same user interface as shown in FIG. 2a except that this shows a different action 305 at a different interval (different point in time). Here the action is another image indicating that the user should move the mouse/finger in a circle in the counter-clockwise direction. Again the user input is validated and appropriately handled as per the flow chart in FIG. 1.

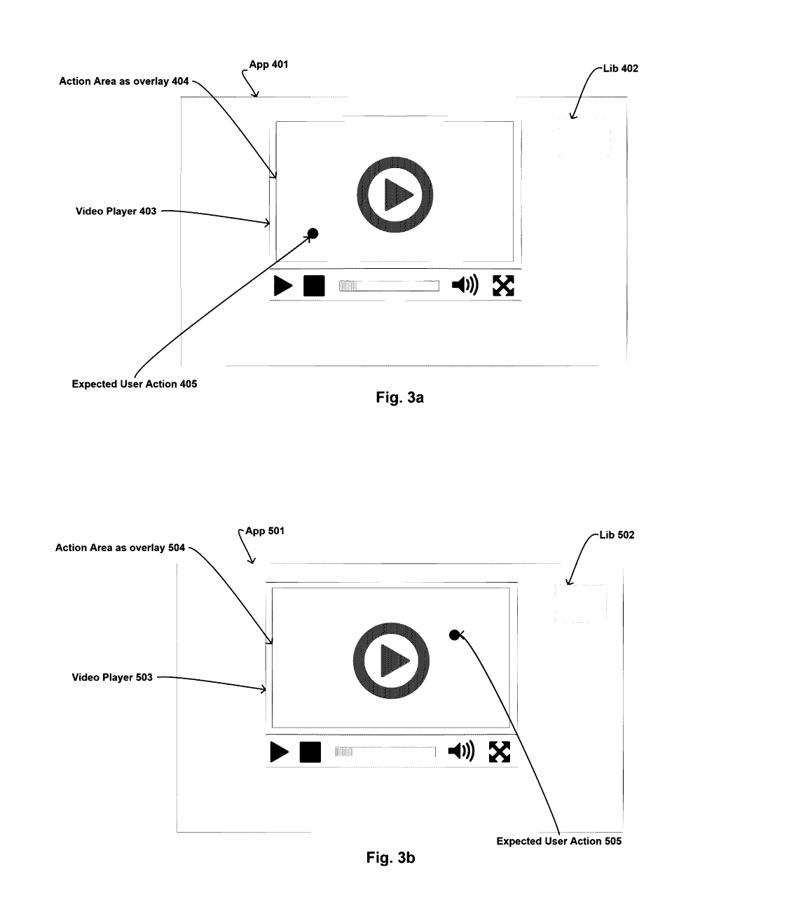

Referring now to FIGS. 3a and 3b, they illustrate a user interface implemented using a “Dynamic Action Area and Fixed Actions” in accordance with an embodiment of the present invention. The app 401 (also 501), Lib 402 (also 502) and video player 403 (also 503) are exactly same as the app 201, lib 202 and video player 203 in FIG. 2a. The main difference when comparing with FIG. 2a is that the action area 404 (also 504) is shown as an overlay on top of the video player. This action area overlay can be transparent. The actions 405 (also 505) are fixed and identical, in this case, it is a dot which appears in somewhere in the action area and the user is expected to either click/touch/swipe on the dot. These fixed actions can be displayed anywhere in this large action area, hence the classification name “Dynamic Action Area and Fixed Actions”. FIG. 3b shows the same action but placed in another position on the action area.

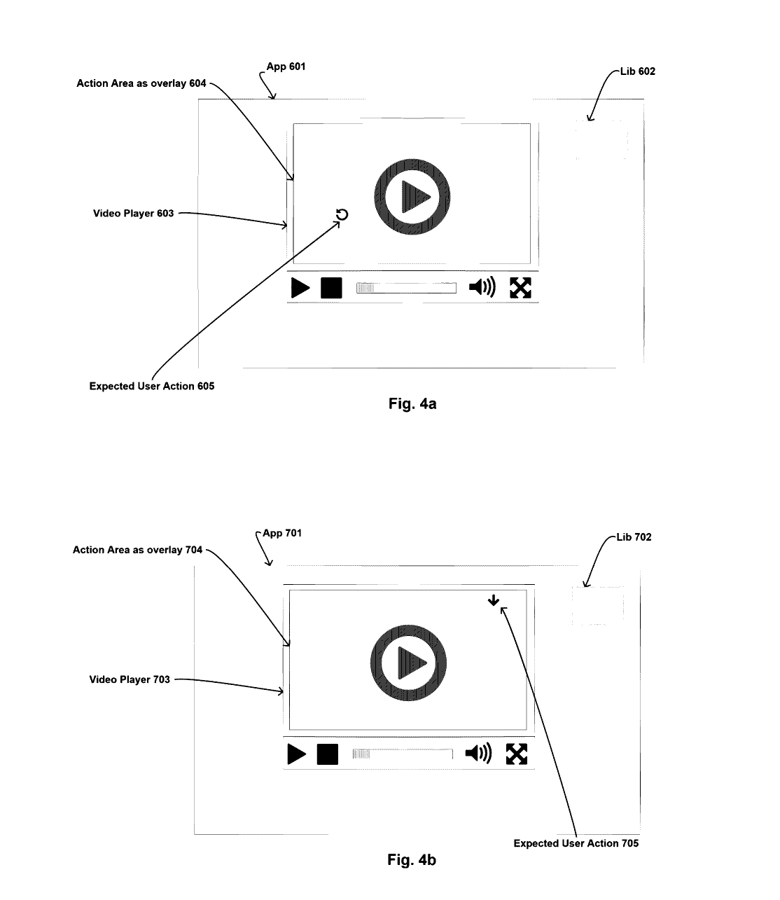

Referring now to FIGS. 4a and 4b, they illustrate a user interface implemented using a “Dynamic Action Area and Dynamic Actions” in accordance with an embodiment of the present invention. The app 601 (also 701), Lib 602 (also 702), video player 603 (also 703) and action area 604 (also 704) are exactly same as the app 401, lib 402, video player 403 and action area 404 in FIG. 3a. The only difference is that actions 605 (also 705) are different in different intervals. These dynamic actions can be displayed anywhere in this large action area, hence the classification name “Dynamic Action Area and Dynamic Actions”.

Referring to FIG. 4a, the action 605 is an image indicating that the user should move the mouse or finger in a circle in the counter-clockwise direction and it appears at a random place in the action area 604. The user input is validated and appropriately handled as per the flow chart in FIG. 1.

Referring to FIG. 4b, the action 705 is an image indicating that the user should move the mouse or finger in the downward direction and it appears at a random place in the action area 704. The user input is validated and appropriately handled as per the flow chart in FIG. 1.

The advantages of the present invention comprise, without limitation,
1. User friendly, simple and non-intrusive actions/responses while making sure that the user had to look at the video till it finished playing.
2. Automated engine to produce actions and validate user responses, so it saves a huge amount of time for both the advertiser and the software application owner.
3. Provides user response data to analyze user interactions and patterns.
4. Can be used in a various types of software applications such as web, desktop or mobile applications etc.
5. Works with different varieties of advertisements such as video, animations, picture slides etc.

In broad embodiment, the present invention is to guarantee that the advertisement is fully viewed by a user, by asking him/her to perform some simple but efficient actions that are non-predictable for the user to make sure that he/she has to continuously watch the advertisement.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A method to make sure that the user has watched any playable digital content completely, comprising:
(a) a software application, written in any computer programming language, targeting any type of platform comprising web, desktop, mobile, wearable device, or television;
(b) a digital content (“digital content”) which can be played over a period of time, comprising videos, animations, or picture slides;
(c) a software component, which periodically produces and shows simple, user-experience- friendly but unpredictable tasks (“expected action”) which instructs the user to perform an action in a specific way;
(d) actual action performed by the user (“response”) which will make sure that he/she is still watching the digital content, and is simple, user-experience-friendly and does not distract the user from watching, comprising moving his/her mouse or fingers (on touch-enabled devices) to replicate the “expected action” in step (c);
(e) a software component, comprising algorithms to validate the user response to determine if the response is correct or not;
(f) a data storing mechanism to store the user response data;
(g) a data analyzing mechanism to analyze the user response data;
(h) a reporting mechanism to provide reports to the advertiser, software application owner and to the user; and
(i) a customization mechanism to customize the entire system;
wherein the said software application displays the said digital content and wants to make sure that the user who is viewing the said digital content is viewing it completely; wherein the said software component produces simple, user-experience-friendly but unpredictable actions for the user to perform, and once the user does the task that he/she is asked to perform, validates the user response to determine if the response is correct or not, thus making sure that the user is actively watching the said digital content; wherein the said data storing mechanism stores the whole data related to the user response for future use; wherein the said data analyzing mechanism process the user response data stored by the said data storing mechanism and performs various analysis to find out useful information about this data; wherein the said reporting mechanism provides reports to the advertiser, software application owner and/or to the user; wherein the said customization mechanism configures and customizes the system.

2. The method of claim 1, wherein showing the “expected action” in step (c) comprising showing an image, animation, computer graphics, wherein these image/animation/graphics instructs the user about a very simple task that the user has to perform without getting distracted while watching the digital content.

3. The method of claim 1, wherein “expected action” in step (c) comprising textual or audio instructions, that instructs the user about a very simple task that the user has to perform without getting distracted while watching the digital content.

4. The method of claim 2, wherein the “expected action” comprising a simple arrow in any directions or a simple shapes or anything which is easier for the user to perform, which the user can mimic with moving the mouse or fingers/stylus in case of touch enabled devices.

5. The method of claim 1, wherein the position of showing the “expected action” in step (c) comprising fixed (showing in a predefined area) or dynamic positioning (showing at a random place), further comprising:
a) showing it on any one side of the digital content close enough to get the attention from user;
b) showing it on any side of the digital content close enough to get the attention from user;
c) over the digital content in any fixed place;
d) over the digital content in any random place; or
e) any combination of the fixed and dynamic positioning.

6. The method of claim 1, wherein period of producing the “expected action” in step (c) comprising fixed or random intervals which are customizable, and is based on the playing time of the digital content.

7. The method of claim 1, wherein the said “response” in step (d) comprising a simple, easy to perform and rough mimicking of the “expected action” in step (c) or following instructions given by “expected action”.

8. The method of claim 1, wherein the said “response” in step (d) comprising moving mouse or fingers/stylus in case of a touch enabled device to mimic the “expected action”, further comprising:
a) moving the mouse/finger towards right if the expected action was an arrow from left to right;
b) moving the mouse/finger towards left if the expected action was an arrow from right to left;
c) moving the mouse/finger downwards if the expected action was an arrow from top to bottom;
d) moving the mouse/finger upwards if the expected action was an arrow from bottom to top;
e) rotating the mouse/finger if the expected action was a circle;
f) moving the mouse/finger in the same way as what ever shown in the expected action;
g) moving towards the position of the shown expected action if the user was instructed so by the expected action;
h) doing whatever is instructed in the expected action with mouse, finger or stylus.

9. The method of claim 8, wherein the mouse movement or finger/stylus movement (in case of touch based devices) comprising a very short and easy action which approximately mimics the expected action, so that the user does not need to take his/her eyes of the digital content.

10. The method of claim 1, wherein the said “algorithms” in step (e) comprising logical statements written in any computer language to verify that the response performed by the user matched the instructions shown to him/her via “expected action”, based on the co-ordinates analysis of the movement of mouse pointer or finger/stylus touch points.

11. The method of claim 10, wherein the co-ordinates analysis of mouse or touch movement comprising a forgiving verification algorithm, which accommodates an imperfect response pattern also, apart from a perfect response, so that it will be more user friendly and accommodating a wide variety of user types worldwide.

12. The method of claim 11, wherein the forgiving verification algorithm considers the minimum number of sampling points (co-ordinates while moving mouse, finger or stylus) to verify the response, lesser the sampling points the more user friendly and easier the responses would be.

13. The method of claim 1, wherein the said “algorithms” in step (e) comprising live verification that the user is paying attention to the digital content.

14. The method of claim 1, wherein when the verification of user response turns out to be incorrect, the system takes various actions to ensure user attention, which can be customized, comprising:
a) pausing the digital content so that the digital content is not proceeding until the user pays attention to it by clicking the play button explicitly;
b) replaying the portion of digital content from previous successful user response till the wrong response;
c) just record the details of the incorrect responses but continue to play the digital content and take actions at the end, such as replaying the whole digital content or marking the user as a partial viewer of the digital content, with or without showing notifications to the user.

15. A method to make sure that the user has watched any playable digital content completely, comprising:
(a) a software application, written in any computer programming language, targeting any type of platform comprising web, desktop, mobile, wearable device, or television;
(b) a digital content (“digital content”) which can be played over a period of time, comprising videos, animations, or picture slides;
(c) a software or hardware component (“advanced user behavior detention component”), which uses advanced user behavior analysis techniques to make sure that he/she is paying attention to the digital content being played, with minimal or no explicit actions to be performed by the user while watching the digital content;
(d) a data storing mechanism to store the user behavior data;
(e) a data analyzing mechanism to analyze the user behavior data;
(f) a reporting mechanism to provide reports to the advertiser, software application owner and to the user; and
(g) a customization mechanism to customize the entire system;
wherein the said software application displays the said digital content and wants to make sure that the user who is viewing the said digital content is viewing it completely; wherein the said ‘advanced user behavior detention component’ makes sure that the user is actively watching the said digital content but with minimal or no actions to be performed by the user while watching the digital content, though it requires minimal interaction from the user before watching the video to get some initial data points; wherein the said data storing mechanism stores the whole data related to the user behavior for future use; wherein the said data analyzing mechanism process the user behavior data stored by the said data storing mechanism and performs various analysis to find out useful information about this data; wherein the said reporting mechanism provides reports to the advertiser, software application owner and/or to the user; wherein the said customization mechanism configures and customizes the system.

16. The method of claim 15, wherein the said “advanced user behavior detention component” in step (c) comprising examining the user's eye movements on a device which has at least one camera.

17. The method of claim 16, wherein the ‘examining the user's eye movement’ comprising finding the position and dimensions of the digital content, finding the boundary of user's eye positions based on these position and dimensions of the digital content, and there after verifying that the user's eye movements are within that boundary while the user watches the digital content.

18. The method of claim 17, wherein ‘finding the position and dimensions of the digital content’ and ‘finding the boundary of user's eye positions based on the position and dimensions of the digital content’ comprising asking the user to perform any actions which reveals the position and dimensions of the digital content as well as the user's eye positions along the boundary of the digital content, further comprising,
(a) clicking or touching (in case of touch enabled devices) on the four corners of the digital content;
(b) clicking or touching (in case of touch enabled devices) on the 2 diagonally opposite corners of the digital content;
(c) clicking or touching (in case of touch enabled devices) on one of the corners of the digital content and in the center of the digital content;
(d) drawing a line along the 2 diagonally opposite corners of the digital content;
(e) drawing a line between one of the corners of the digital content and the center of the digital content;
(f) drawing any shape which reveals the dimensions of the digital content and the user's eye position along the boundary of the digital content;
